(19) United States
(12) Patent Application Publication
(10) Pub. No.: US 2025/0374208 A1
(43) Pub. Date: Dec. 4, 2025

(54) TECHNIQUES FOR ENERGY-EFFICIENT SYNCHRONIZATION SYSTEM BLOCK BEAM MAPPING

(71) Applicant: Lenovo (United States) Inc., Morrisville, NC (US)

(72) Inventors: Karthikeyan Ganesan, Nauheim (DE); Ali Ramadan Ali, Kraiburg am Inn (DE); Ravi Kuchibhotla, Chicago, IL (US)

(21) Appl. No.: 19/300,361

(22) Filed: Aug. 14, 2025

(51) Int. Cl. H04W 56/00; H04W 72/0446; H04W 74/0833

(52) U.S. Cl. CPC H04W 56/001; H04W 72/0446; H04W 74/0833

(57) ABSTRACT

Various aspects of the present disclosure relate to techniques for energy-efficient synchronization system block (SSB) beam mapping. A user equipment is configured to receive signaling from a network indicating a mapping between one or more channels on a per-SSB beam basis; determine, based on the signaling, changes to timing and availability of a dependent channel, wherein the changes to the dependent channel are based on changes in time-domain resources of at least one of the one or more channels; and transmit signaling on one or more channels according to an updated mapping for time-shifted resources, wherein the time-shifted resources include time-domain resources of one or more common channels.

### TECHNICAL FIELD

The present disclosure relates to wireless communications, and more specifically to techniques for energy-efficient synchronization system block (SSB) beam mapping.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to receive signaling from a network indicating a mapping between one or more channels on a per-SSB beam basis; determine, based on the signaling, changes to timing and availability of a dependent channel, wherein the changes to the dependent channel are based on changes in time-domain resources of at least one of the one or more channels; and transmit signaling on one or more channels according to an updated mapping for time-shifted resources, wherein the time-shifted resources include time-domain resources of one or more common channels.

A processor for wireless communication is described. The processor may be configured to, capable of, or operable to receive signaling from a network indicating a mapping between one or more channels on a per-SSB beam basis; determine, based on the signaling, changes to timing and availability of a dependent channel, wherein the changes to the dependent channel are based on changes in time-domain resources of at least one of the one or more channels; and transmit signaling on one or more channels according to an updated mapping for time-shifted resources, wherein the time-shifted resources include time-domain resources of one or more common channels.

A method for wireless communication performed by a UE is described. The method may be configured to, capable of, or operable to receive signaling from a network indicating a mapping between one or more channels on a per-SSB beam basis; determine, based on the signaling, changes to timing and availability of a dependent channel, wherein the changes to the dependent channel are based on changes in time-domain resources of at least one of the one or more channels; and transmit signaling on one or more channels according to an updated mapping for time-shifted resources, wherein the time-shifted resources include time-domain resources of one or more common channels.

An NE for wireless communication is described. The NE may be configured to, capable of, or operable to configure a mapping between one or more channels on a per-SSB beam basis, in response to changes in time-domain resources of at least one of the one or more channels, determine changes to timing and availability of a dependent channel, and signal an updated mapping for time-shifted resources to a UE, wherein the time-shifted resources include time-domain resources of one or more common channels.

A processor for wireless communication is described. The processor may be configured to, capable of, or operable to configure a mapping between one or more channels on a per-SSB beam basis, in response to changes in time-domain resources of at least one of the one or more channels, determine changes to timing and availability of a dependent channel, and signal an updated mapping for time-shifted resources to a UE, wherein the time-shifted resources include time-domain resources of one or more common channels.

A method for wireless communication performed by a NE is described. The method may be configured to, capable of, or operable to configure a mapping between one or more channels on a per-SSB beam basis, in response to changes in time-domain resources of at least one of the one or more channels, determine changes to timing and availability of a dependent channel, and signal an updated mapping for time-shifted resources to a UE, wherein the time-shifted resources include time-domain resources of one or more common channels.

### BRIEF DESCRIPTION OF THE DRAWINGS

FIG. 1 illustrates an example of a wireless communications system, in accordance with aspects of the present disclosure.

FIG. 2 illustrates an embodiment of adapting the position of SS/PBCH block within an SSB burst, in accordance with aspects of the present disclosure.

FIG. 3A illustrates an embodiment of SSB-RO mapping per SSB beam, in accordance with aspects of the present disclosure.

FIG. 3B illustrates an embodiment of SSB-RO mapping per SSB beam, in accordance with aspects of the present disclosure.

FIG. 3C illustrates an embodiment of RO muting/masking, in accordance with aspects of the present disclosure.

FIG. 3D illustrates an embodiment of RO muting/masking and adaptation, in accordance with aspects of the present disclosure.

FIG. 4 illustrates an embodiment of SSB-RO mapping configuration, in accordance with aspects of the present disclosure.

FIG. 5 illustrates an example of a UE, in accordance with aspects of the present disclosure.

FIG. 6 illustrates an example of a processor, in accordance with aspects of the present disclosure.

FIG. 7 illustrates an example of an NE, in accordance with aspects of the present disclosure.

FIG. 8 illustrates a flowchart of a method performed by a UE, in accordance with aspects of the present disclosure.

FIG. 9 illustrates a flowchart of a method performed by an NE, in accordance with aspects of the present disclosure.

### DETAILED DESCRIPTION

Generally, the present disclosure describes systems, methods, and apparatuses for techniques for energy-efficient SSB beam mapping. In certain examples, the methods may be performed using computer-executable code embedded on a computer-readable medium. In certain examples, an apparatus or system may include a computer-readable medium containing computer-readable code which, when executed by a processor, causes the apparatus or system to perform at least a portion of the below described solutions.

In next-generation wireless systems, including 6G, network operators face increasing operational expenses and environmental impact from the energy demands of dense deployments, wide bandwidths, and multi-antenna configurations. While existing 5G NR features such as common channel muting can reduce power consumption, they operate independently for each channel type and do not address interdependencies between channels. For example, muting an SSB beam in a burst saves the transmission power for that beam, but leaves gaps in the time-domain transmission pattern. These gaps prevent the base station from entering deeper sleep states, limiting potential energy savings. Furthermore, legacy SSB-to-random access channel (RACH) occasion (SSB-RO) mapping rules, e.g., as defined in 3GPP TS 38.213 (incorporated herein by reference) are semi-static and do not account for uneven UE distribution or dynamic adaptation of PRACH resources in time and spatial domains. As a result, resources may be over-allocated in low-demand beams and under-utilized in high-demand beams, leading to both wasted spectral capacity and unnecessary energy consumption.

The solutions disclosed herein introduce a coordinated adaptation framework for common channels on a per-SSB beam basis. When an SSB or other common channel is muted, the system also shifts the time-domain resources of associated channels—such as common search space (CCS) monitoring occasions and RACH resource occasions—so that transmissions and receptions are compacted in time. By reducing gaps between active transmissions, the base station can enter light sleep or deep sleep states earlier, improving energy efficiency without sacrificing performance. In addition, the system supports non-uniform SSB-RO mappings, allowing integer, fractional, or zero RO allocations per beam based on actual traffic demand. These mappings can be dynamically signaled using MIB, SIB0, or PDCCH common search spaces, and may include muting or masking bitmaps to indicate inactive resources.

By interlinking the adaptation of SSBs, CCS monitoring occasions, and ROs, the disclosed approach eliminates the inefficiencies of independent channel muting and enables fine-grained, per-beam resource control. This allows the base station to enter low-power states earlier, thereby reducing operational energy costs. Spectral efficiency is improved through demand-based resource allocation, and UE behavior is simplified because muting and shifting information is explicitly signaled and synchronized across related channels. The framework is also flexible enough to support non-backward-compatible 6G deployments without being constrained by legacy mapping rules.

Aspects of the present disclosure are described in the context of a wireless communications system. Note that one or more aspects from different solutions may be combined.

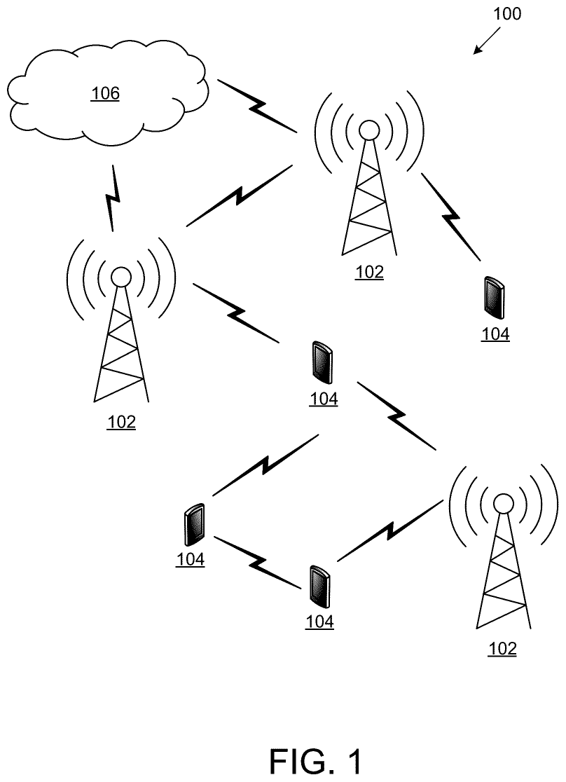

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHz), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In NR systems, e.g., as shown in FIG. 1, SSBs are transmitted periodically to facilitate initial access, time-frequency synchronization, and reception of minimum system information by a UE. The SSB burst structure spans a 5-millisecond (ms) window and typically includes a PSS, an SSS, and a PBCH. Each SSB occupies four Orthogonal Frequency Division Multiplexing (OFDM) symbols and 240 subcarriers, and the default periodicity for SSB transmission is 20 ms. The number of SSBs that can be transmitted within a burst depends on the frequency range and subcarrier spacing (SCS); for example, 8 SSBs are supported in FR1 and up to 64 SSBs in FR2.

Emissions and energy consumption from telecommunication systems significantly impact the environment and contribute to climate change. Operating expenses for delivering telecom services are also substantial. Escalating spectrum costs, capital expenditures, and ongoing RAN maintenance and upgrades, have driven a need for energy-saving measures.

While 5G NR provides substantial improvements in energy efficiency per gigabyte over previous generations, emerging use cases and mmWave adoption require denser deployments with more sites and antennas. Without active intervention, these enhancements could paradoxically increase overall emissions. As noted in 3GPP TR 38.864 (incorporated herein by reference), network energy saving is critical not only for environmental sustainability and reduction of greenhouse gas emissions, but also for controlling operational costs. As 5G expands to support high-data-rate services such as XR, networks are becoming denser, utilizing larger bandwidths and more frequency bands, making novel approaches to energy efficiency essential.

Energy costs already account for a large portion of an operator's total operating expenses, with the majority of this consumption arising from the RAN, particularly the AAU, and a smaller share from data centers and fiber transport. RAN power consumption can be divided into a dynamic portion, used only during active data transmission or reception, and a static portion, consumed continuously to maintain operational readiness even in the absence of data activity. This underscores the need for refined energy-saving strategies, particularly for base stations. While a UE power consumption model exists, e.g., in TR 38.840 (incorporated herein by reference), there is a growing need for a corresponding network model, clear key performance indicators (KPIs), evaluation methodologies, and targeted techniques for energy savings. Such strategies should enable more efficient operation through dynamic or semi-static adaptation of transmissions and receptions, with fine-grained control in time, frequency, spatial, and power domains, potentially with UE assistance and network coordination.

When network energy saving configurations are active-such as idle mode cell DTX or DRX—the transmission of common channels like the paging channel and physical RACH (PRACH) must occur within the cell's active time window. If these transmissions can be condensed or clustered, the base station can enter deep sleep states sooner, yielding greater power savings.

Conventionally, the SSB-to-RO mapping is configured according to a fixed set of rules, e.g., as defined in 3GPP TS 38.213 (incorporated herein by reference): preambles are mapped to SSBs in increasing preamble index order within a PRACH occasion, then in increasing frequency resource index order, then in increasing time resource index order within a PRACH slot, and finally in increasing PRACH slot index order. This static mapping approach becomes suboptimal when PRACH adaptation is introduced for energy savings. Since UE distribution across a cell and its beams is rarely uniform, PRACH resources can and should be adapted both in time and spatial domains. Such adaptation can alter the SSB-RO mapping, requiring the base station to update the configuration accordingly.

Furthermore, when SSBs are adapted or muted within a burst, the corresponding SSB-RO associations are affected. The base station signals the muting of the related ROs for non-transmitted SSB beams to ensure that UEs do not attempt random access on beams that are inactive.

In 5G NR, the association between SSBs and ROs is configured by higher-layer parameters such as ssb-perRACH-OccasionAndCB-PreamblesPerSSB and msg1-FDM. These parameters determine how many SSBs are linked to each RO and the number of contention-based preambles allocated per SSB. The mapping follows a strict priority order: first by preamble index within a PRACH occasion, then by frequency-domain RO index, then by time-domain RO index within a PRACH slot, and finally by PRACH slot index.

For example, in one legacy configuration, 10 SS/PBCH blocks might be transmitted with indices {0, 1, 8, 9, 16, 17, 24, 25, 32, 33}. If two SSBs are mapped to each RO (N=½), and two frequency-division multiplexed ROs and three time-domain ROs per PRACH slot are configured, the mapping is static and evenly distributed according to the fixed rules. Conventional adaptation proposals have included adjusting the number of ROs assigned to each SSB, such as reducing ROs for beams with lower demand, or varying the number of preambles per RO per SSB, such as reducing preambles for SSB #2 to lower gNB computation complexity.

While these methods can optimize certain aspects of PRACH operation, they do not address the impact of muting or shifting in the time domain. Specifically, they fail to remove idle gaps in common channel transmission patterns when certain SSBs are muted. Without compacting transmissions by shifting associated common channels, such as CCS monitoring occasions or PRACH ROs, alongside the muted SSB, the base station cannot effectively enter deeper sleep states. As a result, even with reduced allocations, unused time-domain resources may remain scattered, limiting achievable energy savings.

In Release 19, common channel adaptation primarily involves muting time-domain resources or allocating resources unevenly across beams. While such measures can save power by avoiding transmission or reception in certain intervals, the actual energy savings are largely realized when the base station can enter a micro-sleep state during these idle periods. For 6G, which is not constrained by backward compatibility requirements, a new framework is introduced to enhance energy savings. This framework incorporates muting, shifting of time-domain resources, and uneven per-beam allocation, while also coordinating the muting and shifting of other interrelated common channels. By making the transmission and reception of common channels more compact, the framework reduces gaps between activity periods, enabling the base station to enter light or deep sleep states earlier when no further UE-specific transmission or reception is scheduled.

The solutions described herein provide a common adaptation framework that explicitly links multiple common channels. When an SS/PBCH block is not transmitted, the corresponding common search space, RACH occasion, paging occasion, and RMSI do not need to be monitored by the UE or transmitted by the network. This linkage delivers energy savings for both the UE and the network. In addition, the time-domain resources of these common channels and their interlinked counterparts can be shifted so that remaining transmissions are clustered, further enabling compact operation and earlier entry into low-power states.

Legacy SSB-to-RACH resource partitioning, e.g., as defined by the higher-layer parameter ssb-perRACH-OccasionAndCB-PreamblesPerSSB, is restrictive when implementing PRACH resource adaptation in the time and spatial domains for network energy savings. In many cases, adapting RACH or SSB resources alters the semi-static SSB-to-RO mapping configured in 5G NR via SIB1. To address this, the new SSB-RO mapping rule maps SSBs in increasing SSB index order to ROs in increasing preamble index order for each RO occasion within the configuration period.

The following embodiments describe example implementations of a framework for adapting SSBs and associated common channel resources to improve energy efficiency in next-generation wireless networks. In various examples, the framework enables muting, shifting, and non-uniform allocation of ROs and monitoring occasions on a per-beam basis. By coordinating these adaptations across interrelated channels, the system can reduce idle gaps in transmission patterns, cluster active resources, and enable earlier entry into low-power states such as light sleep or deep sleep. The techniques are applicable to non-backward-compatible 6G deployments and may be signaled using a variety of mechanisms, including broadcast control channels, system information blocks, or dedicated low-power radio channels.

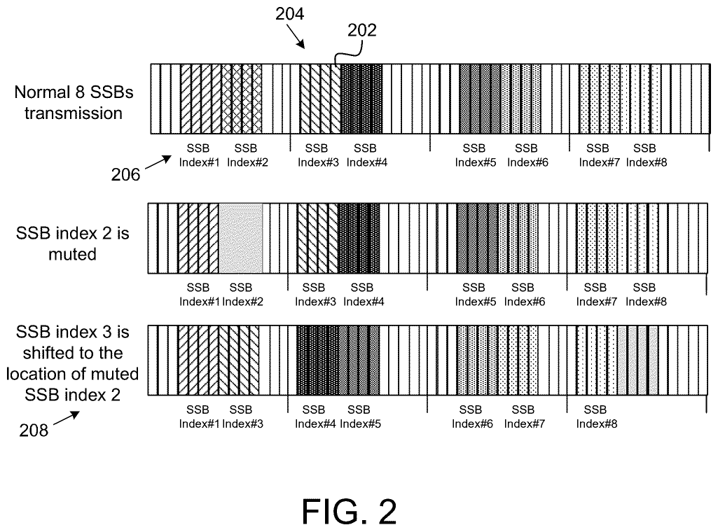

FIG. 2 illustrates an embodiment of adapting the position of SS/PBCH block within an SSB burst, in accordance with aspects of the present disclosure. In a first embodiment, the position of one or more SS/PBCH blocks 202 within an SSB burst 204 can be adapted or shifted in the time domain in order to reduce, or in some cases eliminate, idle gaps between consecutive SSB transmissions. Such shifting can effectively limit the overall SSB burst duration, while maintaining the same number of RACH resources per SSB.

In existing implementations, the SSB beam index 206 may be indicated in the scrambling of the PBCH demodulation reference signal (PBCH DMRS) or in the PBCH DMRS sequence generation. When an SSB beam 202 is not transmitted, a corresponding time-domain gap may be present between SS/PBCH block transmissions within the burst 204. In one example, the time-domain position of an SS/PBCH block can be shifted to occupy the unused gap, thereby reducing the overall burst length and improving the compactness of the transmission.

In conventional mapping, shifting an SS/PBCH block does not affect the corresponding Type-0 common search space (CCS #0) scheduling occasion for the physical downlink control channel (PDCCH) used for required minimum system information (RMSI), because the SS/PBCH-to-CCS #0 mapping is determined by the SSB index, e.g., according to the formula in 3GPP TS 38.213 (incorporated herein by reference). For an SS/PBCH block having index i, the UE determines an index of slot no as no=(O·2\hat{ }μ+└i·M┘) mod Nslot_frame, μ where the frame with system frame number (SFN) satisfies one of two parity conditions: SFN_C mod 2=0 if └(O·2\hat{ }μ+·M┘)/Nslot_frame, μ/mod 2=0, or SFN_C mod 2=1 if └(O·2\hat{ }μ+└i·M′)/Nslot_frame, μ┘ mod 2=1. Here, μ ∈ {0, 1, 2, 3, 5, 6} corresponds to the subcarrier spacing (SCS) for PDCCH receptions in the control resource set (CORESET).

In one example, shifting 208 the time-domain position of an SS/PBCH block 202 within a burst 204 may also include shifting the CCS #0 monitoring occasion associated with that block 202. The slot index in CORESET #0 linked to the SS/PBCH block index 206 can be updated to maintain alignment between the shifted SSB position and its corresponding PDCCH monitoring window.

In another example, one or more ROs corresponding to the shifted SS/PBCH block may also be shifted according to updated SSB-to-RO mapping rules. This combined shifting of SSBs, CCS monitoring occasions, and associated ROs allows transmissions and receptions to be made more compact in time, enabling the cell to enter low-power states such as light sleep or deep sleep earlier.

In one example, for the purposes of SSB-to-CCS #0 monitoring, the SS/PBCH block with index i may be treated as indicating its time-domain location within an SSB burst without changing the beam index methodology for the SS/PBCH block. In another implementation, a logical index based on the actual time position of the SSB within the burst can be defined and used for CCS mapping. In yet another implementation, the SSB beam index can be explicitly signaled in the PDCCH scheduled in the CCS, while the logical index derived from the SSB's placement in the burst is used to determine the CCS mapping per SS/PBCH block.

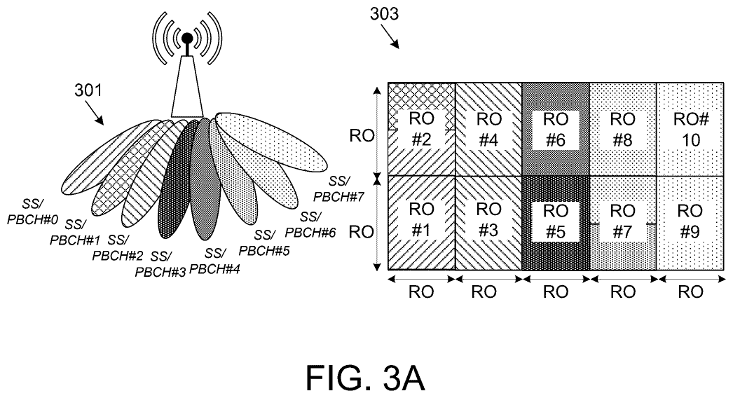

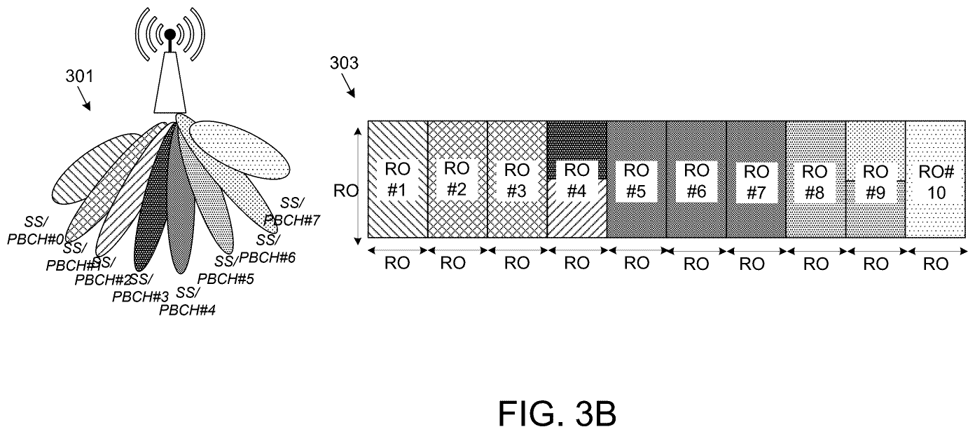

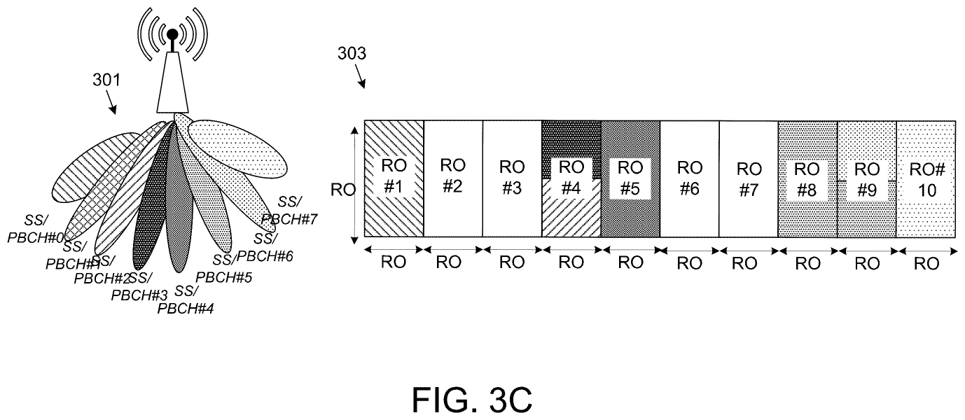

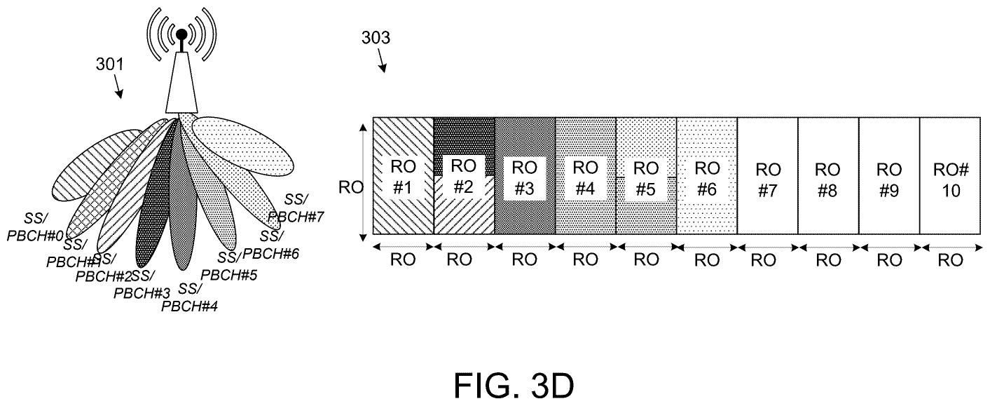

FIG. 3A illustrates an embodiment of SSB-RO mapping per SSB beam, in accordance with aspects of the present disclosure. In a second embodiment, the association between an SS/PBCH block 301 and its corresponding RO 303 can be configured on a per-SSB beam basis such that the number of ROs 303 allocated to each beam is non-uniform. By enabling per-beam RO allocation, the system can adapt resources according to spatial traffic demand, thereby improving efficiency.

In one example, the ROs 303 may be defined in the preamble (or code) domain, the frequency domain, and the time domain, allowing multiple ways to establish the SS/PBCH-to-RO mapping. Dynamic indication of per-beam RO adaptations, or adaptation for a group of beams, can be provided using a corresponding signaling procedure. In another example, the interval for updating RO allocations can be configured relative to specific events or cycles, such as a common search space monitoring occasion, a paging cycle, an SI modification period, a PRACH configuration period, an association period, or an association pattern period.

In one implementation, the SSB-to-RO mapping for each SSB beam can be signaled using one of several options: a Master Information Block (MIB), a System Information Block 0 (SIB0), or a PDCCH Type-0 Common Search Space or other common search space linked to CORESET #0. In this example, an index value may be transmitted, where the index points to an entry in a predefined mapping table of SSB-RO associations. For instance, if the table has eight entries, a 3-bit index can be used. In another example, the table entries can correspond to values similar to those defined for ssb-perRACH-OccasionAndCB-PreamblesPerSSB (e.g., ⅛, ¼, ½, 1, 2, 4, 8, 16), where each value represents the ratio of SSBs to ROs.

The SSB-RO mapping may include integer values, fractional (non-integer) values, or combinations thereof, and may be configured separately for each SSB beam or for a group of beams. Mapping of RACH resources can follow the 5G NR legacy rule, in which allocation is prioritized first by preamble index, second by frequency domain, third by time-domain ROs within a PRACH slot, and fourth by PRACH slot index.

In one example, where Msg-1-FDM (frequency-division multiplexing of RACH occasions) is configured as 2, the allocation of SSB indexes 301 to ROs 303 might be as follows: SSB index #0=3/2, SSB index #1=1/2, SSB index #2=2, SSB index #3=1, SSB index #4=1, SSB index #5=1/2, SSB index #6=3/2, and SSB index #7=2. The factor 3/2 for SSB index #0 may correspond to mapping that beam to 1.5 ROs, with the first full RO allocated in the time domain and the second RO allocated in part (e.g., half) in the frequency domain, meaning all preambles in RO #1 and half of the preambles in RO #2 are assigned to SSB index #0.

FIG. 3B illustrates an embodiment of SSB-RO mapping per SSB beam, in accordance with aspects of the present disclosure. In another example, where Msg-1-FDM is configured as 1, the allocation of SSB indexes to ROs 303 might be: SSB index #0=1, SSB index #1=2, SSB index #2=1/2, SSB index #3=1/2, SSB index #4=3, SSB index #5=3/2, SSB index #6=1/2, and SSB index #7=1. In this case, the value 1 for SSB index #0 corresponds to mapping the beam to one full RO, meaning all preambles within RO #1 are assigned to that beam.

FIG. 3C illustrates an embodiment of RO muting/masking, in accordance with aspects of the present disclosure. In one implementation, a muting or masking bitmap for ROs 303 can be signaled to the UE to indicate unavailable ROs 303 for RACH transmission. The muting/masking pattern may apply to all configured ROs 303 corresponding to a given set of SSB beams 301 within a RACH cycle or association period. In one example, the muting/masking bitmap “1001100111” indicates that RO #2, RO #3, RO #6, and RO #7 are muted. Such patterns can be valid for a configuration period, association period, or association pattern period. The muting/masking information can also be signaled using MIB, SIB0, or a PDCCH Type-0 Common Search Space or other CORESET #O-linked common search space.

FIG. 3D illustrates an embodiment of RO muting/masking and adaptation, in accordance with aspects of the present disclosure. In another example, SSB-RO mapping may be adapted to reduce RO monitoring at the base station and to reduce gaps between ROs 303 in the time domain, thereby clustering ROs 303 for more compact operation. A subset of SSB beams 301 may be configured with zero ROs 303, meaning no ROs 303 are associated with those beams. A zero value can be included as a valid entry in the SSB-RO mapping table.

In another example, both muting/masking and per-beam SSB-RO mapping can be applied together. From the set of available PRACH occasions in the PRACH configuration, muting or masking can first be applied to configured ROs 303. Per-beam SSB-RO mapping can then be applied to the remaining ROs 303 so that the number of ROs 303 per beam is preserved within the PRACH configuration period. In another option, muted ROs 303 can be reassigned to unused ROs 303 according to the same mapping rules used before muting/masking. In yet another option, if SSB-RO allocation extends beyond the number of PRACH slots configured for the PRACH configuration period, excess ROs 303 can be dropped. These approaches may also be combined.

In another implementation, when sub-band full duplex (SBFD) is configured, the network may have uplink sub-bands within an SBFD slot that include ROs 303. In one example, the SSB-RO mapping configuration may prioritize ROs 303 in pure uplink slots first, followed by ROs 303 in the uplink sub-bands of SBFD slots. These additional ROs 303 may be muted or masked dynamically based on interference levels, energy-saving requirements, or usage conditions.

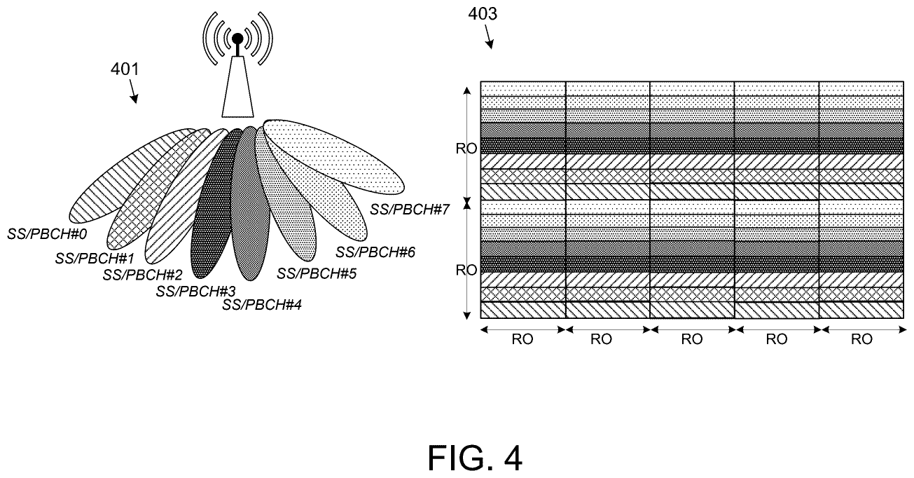

FIG. 4 illustrates an embodiment of SSB-RO mapping configuration, in accordance with aspects of the present disclosure. In another example, SSB-RO mapping and muting/masking patterns can be configured cyclically across PRACH preambles in all valid ROs 403. The mapping order of transmitted SS/PBCH blocks 401 to preambles can follow an increasing SS/PBCH block index order mapped to an increasing RACH preamble index order in all valid ROs 403.

In a third embodiment, when a candidate SSB within an SSB burst is not transmitted, the ROs associated with that SSB can be muted. By muting these ROs, the UE is prevented from attempting random access on beams that are inactive, thereby avoiding unnecessary uplink transmissions and reducing power consumption on both the UE and network sides. The validity of the muting or masking for such ROs may be constrained to an association period between the SSB and its corresponding ROs.

In another example, muted ROs may also be shifted in time in accordance with the SSB-to-RO mapping rules described in other embodiments. By shifting these ROs, the network can cluster the remaining active ROs in the time domain, resulting in a more compact overall transmission pattern. This compacting effect can reduce idle gaps between transmissions, enabling the base station to enter light sleep or deep sleep states earlier, thereby increasing energy savings.

In yet another example, when an SS/PBCH block corresponding to a non-transmitted SSB is muted, the UE may refrain from monitoring the Type-0 common search space (CCS #0) monitoring occasion associated with that SS/PBCH block. Skipping CCS #0 monitoring in these cases further reduces UE power consumption and eliminates unnecessary control channel monitoring for beams that are inactive.

In one implementation, the combination of muting, shifting, and selective monitoring avoidance can be applied dynamically based on network scheduling decisions, traffic patterns, or energy-saving policies. In another implementation, these adaptations can be signaled to the UE through higher-layer signaling or through PDCCH-based signaling in a common search space linked to CORESET #0.

In a fourth embodiment, a signal transmitted to a low-power radio (LPR) of a UE can be used to broadcast information related to the adaptation of one or more common signals or channels. The low-power radio may operate in a reduced-power mode and remain active primarily for the purpose of receiving such adaptation information, thereby minimizing the UE's overall energy consumption.

In another example, a set of UEs can be grouped into a “common group” for the purposes of adaptation signaling. A dedicated monitoring occasion can be defined for the group, during which the UEs receive broadcast adaptation information applicable to one or more common signals or channels. This approach allows the network to efficiently distribute adaptation parameters to multiple UEs at once, rather than signaling each UE individually.

The adaptation information broadcast to the group may include SSB-per-RO association information, updated mappings or allocation factors for per-beam RACH occasions, muting information for one or more resource occasions of a common channel associated with a given SSB beam, or muting information for a common channel's burst period such as an SSB burst or an SSB-RACH association period. In one implementation, the adaptation information can be transmitted periodically via the low-power radio, synchronized with association periods or other relevant configuration cycles. In another implementation, the adaptation information may be transmitted on demand, triggered by network-side events such as traffic changes, beam muting decisions, or updates to per-beam resource allocations. This mechanism ensures that UEs are aware of current mapping and muting configurations without requiring the main receiver to remain continuously active.

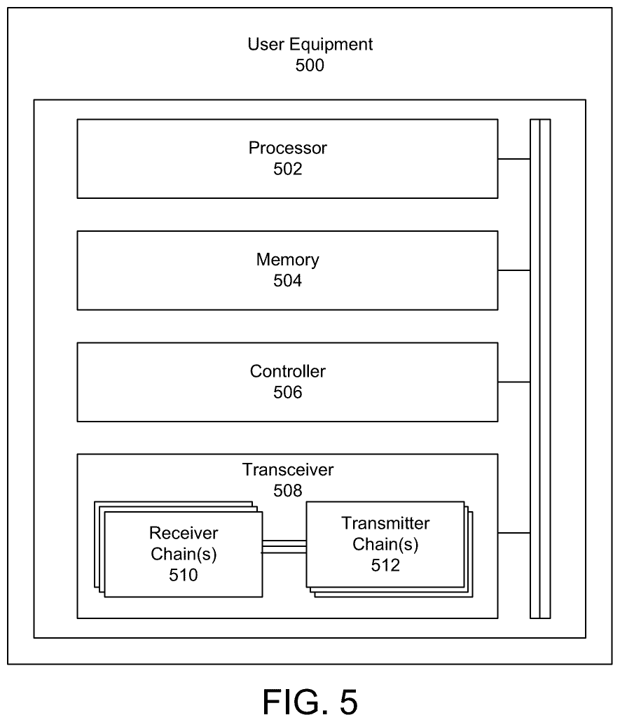

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions that, when executed by the processor 502, cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the UE functions described herein (e.g., executing, by the processor 502, instructions stored in the memory 504). Accordingly, the processor 502 may support wireless communication at the UE 500 in accordance with examples as disclosed herein.

In one example, the UE 500 is configured to receive signaling from a network indicating a mapping between one or more channels on a per-SSB beam basis, determine, based on the signaling, changes to timing and availability of a dependent channel, wherein the changes to the dependent channel are based on changes in time-domain resources of at least one of the one or more channels, and transmit signaling on one or more channels according to an updated mapping for time-shifted resources, wherein the time-shifted resources include time-domain resources of one or more common channels.

In one embodiment, the one or more common channels comprise SSBs, common search space monitoring occasions, and ROs. In one embodiment, the mapping indicates integer, fractional, or non-integer values of one or more channels per SSB beam.

In one embodiment, the UE 500 is configured to receive signaling indicating an index referencing a predefined mapping table, the mapping table comprising entries defining associations between SSBs and one or more channels. In one embodiment, the UE is configured to receive signaling indicating a muting or masking bitmap to indicate one or more channels that are deactivated for non-transmitted SSB beams.

In one embodiment, the mapping is signaled via a PDCCH Type-0 Common Search Space associated with CORESET #0. In one embodiment, the UE 500 is configured to receive signal timing adjustment information to ensure synchronization with one or more shifted common channels.

In one embodiment, the UE 500 is configured to disregard monitoring a common search space corresponding to a muted SSB beam. In one embodiment, the mapping specifies per-beam allocations of time-domain resources of one or more channels. In one embodiment, the UE 500 is configured to transmit signaling on a channel according to the updated mapping in response to its time-domain resources being indicated as active in a received muting or masking pattern.

The controller 506 may manage input and output signals for the UE 500. The controller 506 may also manage peripherals not integrated into the UE 500. In some implementations, the controller 506 may utilize an operating system (OS) such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding/processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

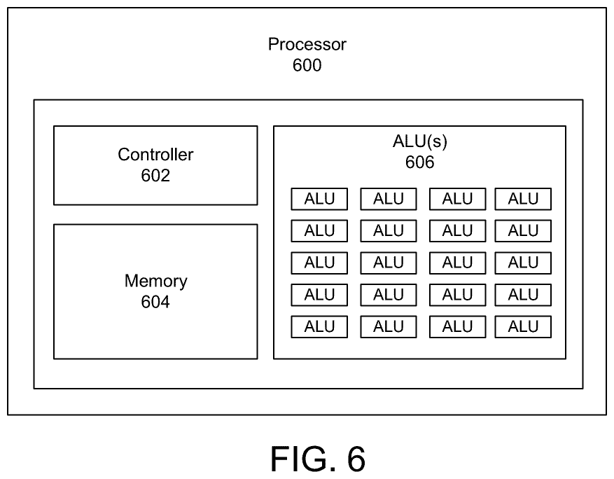

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

In various examples, the processor 600 may support wireless communication of a UE, in accordance with examples as disclosed herein. In other examples, the processor 600 may support wireless communication of a RAN entity, in accordance with examples as disclosed herein.

In one example, a processor 600 is configured to receive signaling from a network indicating a mapping between one or more channels on a per-SSB beam basis, determine, based on the signaling, changes to timing and availability of a dependent channel, wherein the changes to the dependent channel are based on changes in time-domain resources of at least one of the one or more channels, and transmit signaling on one or more channels according to an updated mapping for time-shifted resources, wherein the time-shifted resources include time-domain resources of one or more common channels.

In one embodiment, the one or more common channels comprise SSBs, common search space monitoring occasions, and ROs. In one embodiment, the mapping indicates integer, fractional, or non-integer values of one or more channels per SSB beam.

In one embodiment, the processor 600 is configured to receive signaling indicating an index referencing a predefined mapping table, the mapping table comprising entries defining associations between SSBs and one or more channels. In one embodiment, the processor 600 is configured to receive signaling indicating a muting or masking bitmap to indicate one or more channels that are deactivated for non-transmitted SSB beams.

In one embodiment, the mapping is signaled via a PDCCH Type-0 Common Search Space associated with CORESET #0. In one embodiment, the processor 600 is configured to receive signal timing adjustment information to ensure synchronization with one or more shifted common channels.

In one embodiment, the processor 600 is configured to disregard monitoring a common search space corresponding to a muted SSB beam. In one embodiment, the mapping specifies per-beam allocations of time-domain resources of one or more common channels. In one embodiment, the processor 600 is configured to transmit signaling on a channel according to the updated mapping in response to its time-domain resources being indicated as active in a received muting or masking pattern.

In one embodiment, the processor 600 is configured to configure an mapping between one or more channels on a per-SSB beam basis, in response to changes in time-domain resources of at least one of the one or more channels, determine changes to timing and availability of a dependent channel, and signal an updated mapping for time-shifted resources to a UE, wherein the time-shifted resources include time-domain resources of one or more common channels.

In one embodiment, the one or more common channels comprise SSBs, common search space monitoring occasions, and ROs. In one embodiment, signaling of the mapping is performed using one of a MIB, SIB0, or DCI. In one embodiment, the processor 600 is configured to apply a muting or masking pattern prior to allocating per-SSB beam mappings of time-domain resources of one or more channels.

In one embodiment, the processor 600 is configured to cyclically apply the muting or masking patterns over a physical RACH configuration period. In one embodiment, the processor 600 is configured to reallocate time-domain resources of one or more channels from muted SSB beams to unused resources while preserving an SSB-to-channel mapping order.

In one embodiment, the processor 600 is configured to shift the time-domain resources of one or more common channels within a physical RACH configuration period. In one embodiment, the processor 600 is configured to shift time-domain resources of one or more common channels across an SSB burst.

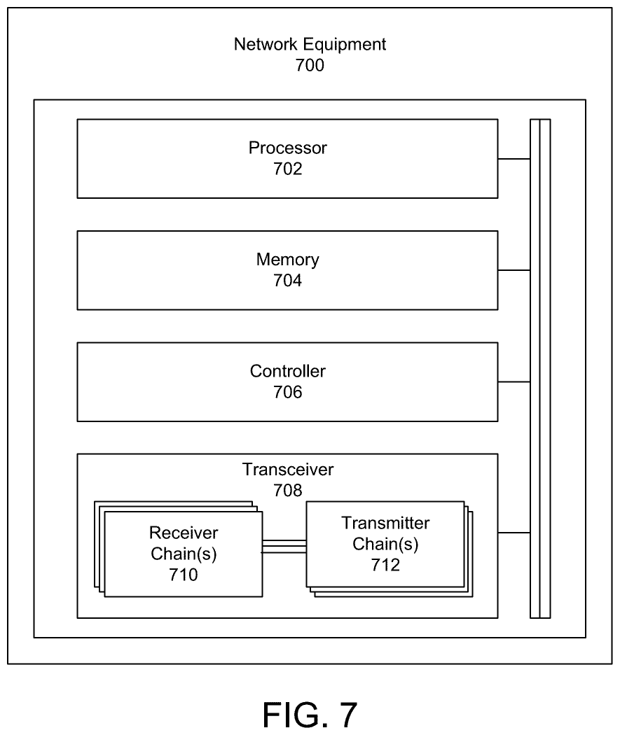

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the RAN functions described herein (e.g., executing, by the processor 702, instructions stored in the memory 704). For example, the processor 702 may support wireless communication at the NE 700 in accordance with examples as disclosed herein.

In one embodiment, the NE 700 is configured to configure an mapping between one or more channels on a per-SSB beam basis, in response to changes in time-domain resources of at least one of the one or more channels, determine changes to timing and availability of a dependent channel, and signal an updated mapping for time-shifted resources to a UE, wherein the time-shifted resources include time-domain resources of one or more common channels.

In one embodiment, the one or more common channels comprise SSBs, common search space monitoring occasions, and ROs. In one embodiment, signaling of the mapping is performed using one of a MIB, SIB0, or DCI. In one embodiment, the NE 700 is configured to apply a muting or masking pattern prior to allocating per-SSB beam mappings of time-domain resources of one or more channels.

In one embodiment, the NE 700 is configured to cyclically apply the muting or masking patterns over a physical RACH configuration period. In one embodiment, the NE 700 is configured to reallocate time-domain resources of one or more channels from muted SSB beams to unused resources while preserving an SSB-to-channel mapping order.

In one embodiment, the NE 700 is configured to shift the time-domain resources of one or more common channels within a physical RACH configuration period. In one embodiment, the NE 700 is configured to shift time-domain resources of one or more common channels across an SSB burst.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

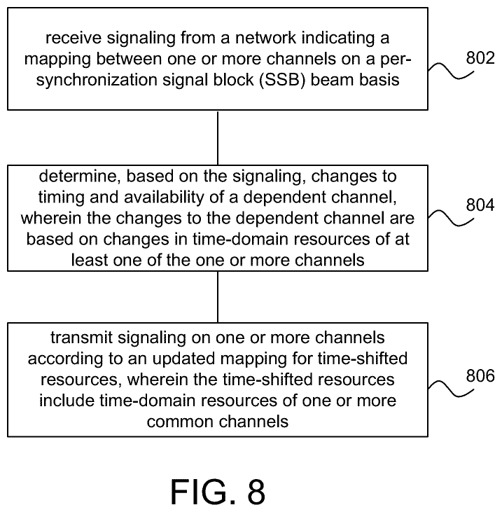

FIG. 8 illustrates a flowchart of a method performed by a UE 500 in accordance with aspects of the present disclosure. The operations of the method may be implemented by a UE 500 as described herein. In some implementations, the UE 500 may execute a set of instructions to control the function elements of the UE 500 to perform the described functions.

At step 802, the method may receive signaling from a network indicating a mapping between one or more channels on a per-SSB beam basis. The operations of step 802 may be performed in accordance with examples as described herein. In some implementations, aspects of the operations of step 802 may be performed by a UE 500, as described with reference to FIG. 5.

At step 804, the method may determine, based on the signaling, changes to timing and availability of a dependent channel, wherein the changes to the dependent channel are based on changes in time-domain resources of at least one of the one or more channels. The operations of step 804 may be performed in accordance with examples as described herein. In some implementations, aspects of the operations of step 804 may be performed by a UE 500, as described with reference to FIG. 5.

At step 806, the method may transmit signaling on one or more channels according to an updated mapping for time-shifted resources, wherein the time-shifted resources include time-domain resources of one or more common channels. The operations of step 806 may be performed in accordance with examples as described herein. In some implementations, aspects of the operations of step 806 may be performed by a UE 500, as described with reference to FIG. 5.

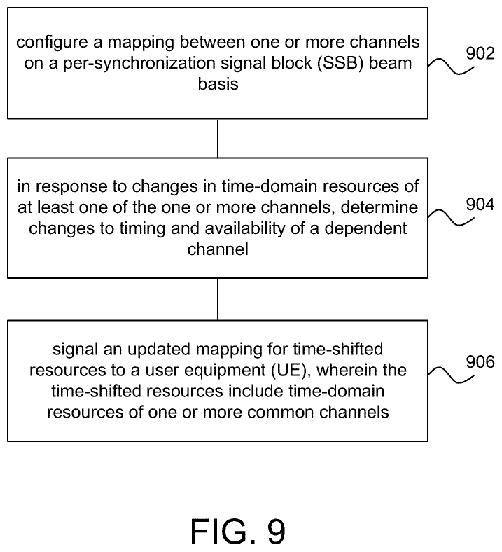

FIG. 9 illustrates a flowchart of a method performed by an NE 700 in accordance with aspects of the present disclosure. The operations of the method may be implemented by a NE 700 as described herein. In some implementations, the NE 700 may execute a set of instructions to control the function elements of the NE 700 to perform the described functions.

At step 902, the method may configure a mapping between one or more channels on a per-SSB beam basis. The operations of step 902 may be performed in accordance with examples as described herein. In some implementations, aspects of the operations of step 902 may be performed by a NE 700, as described with reference to FIG. 7.

At step 904, the method may, in response to changes in time-domain resources of at least one of the one or more channels, determine changes to timing and availability of a dependent channel. The operations of step 904 may be performed in accordance with examples as described herein. In some implementations, aspects of the operations of step 904 may be performed by a NE 700, as described with reference to FIG. 7.

At step 906, the method may signal an updated mapping for time-shifted resources to a UE, wherein the time-shifted resources include time-domain resources of one or more common channels. The operations of step 906 may be performed in accordance with examples as described herein. In some implementations, aspects of the operations of step 906 may be performed by a NE 700, as described with reference to FIG. 7.

It should be noted that the method described herein describes one possible implementation, and that the operations and the steps may be rearranged or otherwise modified and that other implementations are possible.

It should be noted that the method described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive signaling from a network indicating a mapping between one or more channels on a per-synchronization signal block (SSB) beam basis;
determine, based on the signaling, changes to timing and availability of a dependent channel, wherein the changes to the dependent channel are based on changes in time-domain resources of at least one of the one or more channels; and
transmit signaling on one or more channels according to an updated mapping for time-shifted resources, wherein the time-shifted resources include time-domain resources of one or more common channels.

2. The UE of claim 1, wherein the one or more common channels comprise SSBs, common search space monitoring occasions, and random access channel (RACH) resource occasions (ROs).

3. The UE of claim 1, wherein the mapping indicates integer, fractional, or non-integer values of the one or more channels per SSB beam.

4. The UE of claim 1, wherein the at least one processor is configured to cause the UE to receive signaling indicating an index referencing a predefined mapping table, the mapping table comprising entries defining associations between SSBs and one or more channels.

5. The UE of claim 1, wherein the at least one processor is configured to cause the UE to receive signaling indicating a muting or masking bitmap to indicate one or more channels that are deactivated for non-transmitted SSB beams.

6. The UE of claim 1, wherein the mapping is signaled via a physical downlink control channel (PDCCH) Type-0 Common Search Space associated with core resource set #0 (CORESET #0).

7. The UE of claim 1, wherein the at least one processor is configured to cause the UE to receive signal timing adjustment information to ensure synchronization with one or more shifted common channels.

8. The UE of claim 1, wherein the at least one processor is configured to cause the UE to disregard monitoring a common search space corresponding to a muted SSB beam.

9. The UE of claim 1, wherein the mapping specifies per-beam allocations of time-domain resources of one or more channels.

10. The UE of claim 1, wherein the at least one processor is configured to cause the UE to transmit signaling on a channel according to the updated mapping in response to its time-domain resources being indicated as active in a received muting or masking pattern.

11. A method of a user equipment (UE), comprising:
receiving signaling from a network indicating a mapping between one or more channels on a per-synchronization signal block (SSB) beam basis;
determining, based on the signaling, changes to timing and availability of a dependent channel, wherein the changes to the dependent channel are based on changes in time-domain resources of at least one of the one or more channels; and
transmitting signaling on one or more channels according to an updated mapping for time-shifted resources, wherein the time-shifted resources include time-domain resources of one or more common channels.

12. A network equipment (NE) for wireless communication, comprising:
at least one memory; and
at least one processor coupled with the at least one memory and configured to cause the NE to:
configure a mapping between one or more channels on a per-synchronization signal block (SSB) beam basis;
in response to changes in time-domain resources of at least one of the one or more channels, determine changes to timing and availability of a dependent channel; and
signal an updated mapping for time-shifted resources to a user equipment (UE), wherein the time-shifted resources include time-domain resources of one or more common channels.

13. The NE of claim 12, wherein the one or more common channels comprise SSBs, common search space monitoring occasions, and random access channel (RACH) resource occasions (ROs).

14. The NE of claim 12, wherein signaling of the mapping is performed using one of a Master Information Block (MIB), System Information Block (SIB0), or Downlink Control Information (DCI).

15. The NE of claim 12, wherein the at least one processor is configured to cause the NE to apply a muting or masking pattern prior to allocating per-SSB beam mappings of time-domain resources of one or more channels.

16. The NE of claim 15, wherein the at least one processor is configured to cause the NE to cyclically apply the muting or masking patterns over a physical random access channel (RACH) configuration period.

17. The NE of claim 12, wherein the at least one processor is configured to cause the NE to reallocate time-domain resources of one or more channels from muted SSB beams to unused resources while preserving an SSB-to-channel mapping order.

18. The NE of claim 12, wherein the at least one processor is configured to cause the NE to shift the time-domain resources of one or more common channels within a physical random access channel (RACH) configuration period.

19. The NE of claim 12, wherein the at least one processor is configured to cause the NE to shift time-domain resources of one or more common channels across an SSB burst.

20. A method of a network equipment (NE), comprising:
configuring a mapping between one or more channels on a per-synchronization signal block (SSB) beam basis;
in response to changes in time-domain resources of at least one of the one or more channels, determining changes to timing and availability of a dependent channel; and
signaling an updated mapping for time-shifted resources to a user equipment (UE), wherein the time-shifted resources include time-domain resources of one or more common channels.
